(19) United States
(12) Patent Application Publication
(10) Pub. No.: US 2011/0176162 A1
(43) Pub. Date: Jul. 21, 2011

(54) PRINTER INSTALLATION AT A CLOUD SERVER

(76) Inventors: Harish B. Kamath, Bengalooru Karanataka (IN); Hean Koon Koay, Singapore (SG); Vss Iyer, Chennai Tamil Nadu (IN)

(21) Appl. No.: 12/689,254

(22) Filed: Jan. 19, 2010

(51) Int. Cl. G06F 3/12

(52) U.S. Cl. 358/1.15

(57) ABSTRACT

One embodiment is directed to installing a printer at a server. The printer transmits a unique identification and printing properties to the server during installation.

### BACKGROUND

Installing a printer with a print server can be a lengthy and technical process that requires a series of manual steps that a user performs. Details of the installation are specific to each printer and can vary depending on factors such as the capabilities of the printer, method of connection, desired configuration parameters for the printer, etc. Also, the installation process is typically restricted to operate within the firewall and must have administrative privileges.

Most users do not know or understand the complex set of procedures needed to install a printer to a remote print server.

### BRIEF DESCRIPTION OF THE DRAWINGS

FIG. 1 shows a cloud print system in accordance with an example embodiment of the present invention.

FIG. 2 shows a flow diagram connecting a printer to a cloud print server in accordance with an example embodiment of the present invention.

FIG. 3 shows a flow diagram installing a printer with a cloud print server in accordance with an example embodiment of the present invention.

FIG. 4 shows a diagram of a user and printer communicating with a cloud print server in accordance with an example embodiment of the present invention.

FIG. 5 is a computer system in a cloud print-system in accordance with an example embodiment of the present invention.

### DETAILED DESCRIPTION

Example embodiments in accordance with the invention relate to systems and methods that install a printer or electronic device to a cloud print server.

In one embodiment, users install printers over the internet with an Internet Print Service (ISP). Printers and other electronic devices (including multi-functional devices that scan, copy, and/or print) are installed with an installation process that includes identifying the user and printer, configuring print parameters and other settings, and registering the user and printer with a cloud print server. The installation process includes an automated mechanism to install printers with the ISP and be self-configured to start receiving print jobs after installation.

Example embodiments facilitate the installation process of a printer over a network to a remote server. For example, the installation process for users is simplified since few steps are used. Technical expertise is not required since installation is largely automated with few manual steps performed by the user. Installation of the printer can occur without a user having knowledge of printer capabilities, such as printer language being supported, printer resolution, duplex capability, etc.

During installation printers are uniquely identified, and identification occurs independently of TCP/IP network in which the printer is physically located (TCP/IP is an. Internet Protocol Suite: Transmission Control Protocol and Internet Protocol). The installation process with example embodiments also overcomes firewall restrictions that normally hinder web services access to network peripherals. Installation can occur inside or across a firewall. Installation occurs without, for example, configuration of network elements and configurations of a router.

With example embodiments, a printer can automatically access internet print services out-of-the-box. In other words, after purchasing a new printer, a user can remove the printer from its packaging, power-on the printer, and connect it to the internet to initiate an automated process to install the printer to an ISP. This process is particularly useful in unmanaged network environments, such as home network environments.

After the printer connects to the ISP and the user performs a few steps, the user can print to the printer from a remote electronic device. Users are able to print emails, documents, photos, web pages, etc. from a variety of different portable devices. Mobile users can print to one or more printers from any worldwide location that provides internet access, regardless of whether the user is located at home, in the office, on the road, in a foreign country, etc. The print services provided by the cloud print system are printer-agnostic and driverless (i.e., the computers of the users are not required to have a print driver: software that converts data to be printed to a form specific to the printer). Although one embodiment uses driverless systems, other embodiments have printing through a driver to print services from client platforms. For example, the driver can be a universal print driver, and the print service translates data to be printer specific. Furthermore in one embodiment, functions of the print driver are provided by the cloud, not the user computer that initiated the print job request.

In one embodiment, the printer automatically provides a unique identification to the ISP or cloud server upon being removed from the box after purchase and connected to the internet. By way of example, the printer sends the ISP a combination of a-product identification and printer identification, or a pair of a public key and a private key occurs between the printer and ISP. This exchange occurs as part of an auto-setup phase during installation.

After the printer is uniquely identifies itself to the ISP, the printer automatically communicates its properties to the ISP. An example is enabling color output only if the printer supports color output. The printer properties are stored and installed into the cloud print system by making use of REST API by the printer. Once the printer identity is established with the cloud print system, a sequence of operations occurs. By way of example, such operations can include
1. Validation of connectivity of the printer to the cloud print service;
2. Recognition by the cloud print service of receiving the printer parameters and being able to process such information (for example, acknowledge is provided with visible output at the printer).

During the auto-setup phase, ownership of the printer is also established. The cloud print service assigns or designates each printer with an owner (for example, a person who has not only printing rights but also administrative rights). Confirmation of this ownership can occur at the printer (for example, the printer prints a test page or displays acknowledgement of ownership on a display). Furthermore, the printer can also confirm successful installation of the printer to the cloud print service (for example, with a printout, display message, email or text to owner, etc.).

In another example embodiment, ownership is established after the printer is installed with the cloud server. In this instance, the user ID, user password, and unique identification of the printer are used for tagging ownership.

In one example embodiment, once ownership is established, a unique identification is provided to the owner (for example, the owner is provided with a user ID and a password is associated with the user ID). Thereafter, the user can login to cloud print service with the user ID and password and print to the printer. Login can occur from any worldwide location with network or internet access (such as a user logging in with a remote portable electronic device and sending a print job to the printer). From the printer or a remote electronic device, the owner can also perform various system changes to the printer (such as changing default print setup for the printer, changing username and/or password, designating other individuals with printing rights to the printer, etc.).

In one embodiment, installation of the printer with the cloud print service occurs without the use of a personal computer (PC). Communication between the printer and cloud print service is sufficient to install the printer with the cloud and enable subsequent remote printing with an electronic device by the owner.

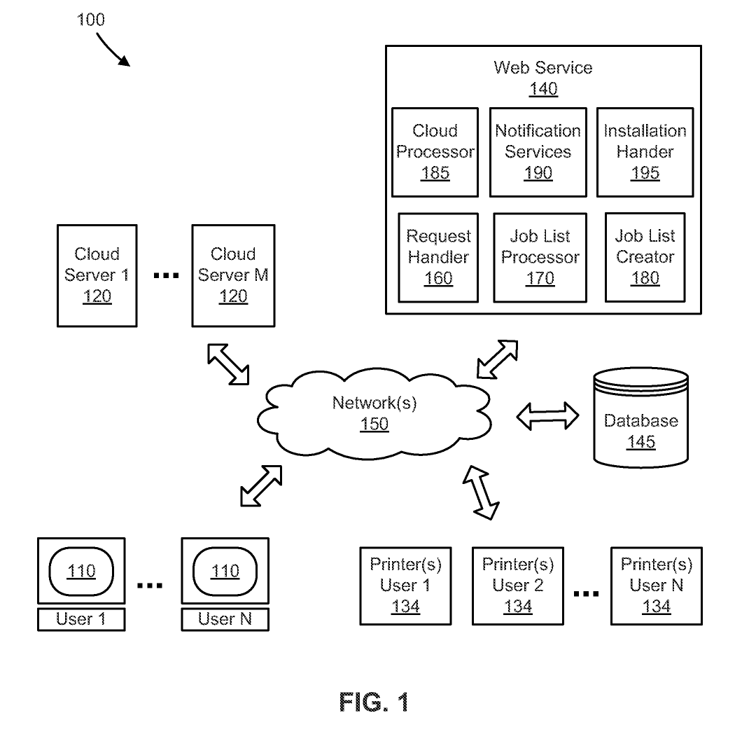

FIG. 1 shows a cloud print system 100 in accordance with an example embodiment of the present invention. The system includes a plurality of users or computers 110 (shown as user 1 to user N), a plurality of cloud servers 120 (shown as cloud server 1 to cloud server M), a plurality of printers 134 for the users, a web service 140, and a database 145 in communication with each other through one or more networks 150 (such as the internet and world wide web or web). The web service 140 further includes a request handler 160, job list processor 170, job list creator 180, cloud processor 185, notification services 190, and installation handler 195. The cloud processor 185 performs processing functions for the cloud, and the notification services 190 notifies a user, computer, or administrator of job status, such as print job complete, printing error, etc. The installation handler 195 communicates with the printers 134 to install the printers, as discussed herein with example embodiments.

The cloud print system provides printing services to users who connect to the cloud through the internet. Users are able to print to their printers from different geographical locations around the world upon installing a printer and establishing ownership or user rights with the printer.

Generally, a print job work item is performed with the following operations: handling user requests, creating a job list, and processing the job list. The print job request handler 160 acts on user requests. The job list creator 180 creates job steps, and the job list processor 170 executes the job steps according to the assigned priorities. These tasks are more fully discussed in U.S. patent application having Ser. No. 12/544,223 entitled “Web Printing” which was filed 20 August 2009 and incorporated herein by reference.

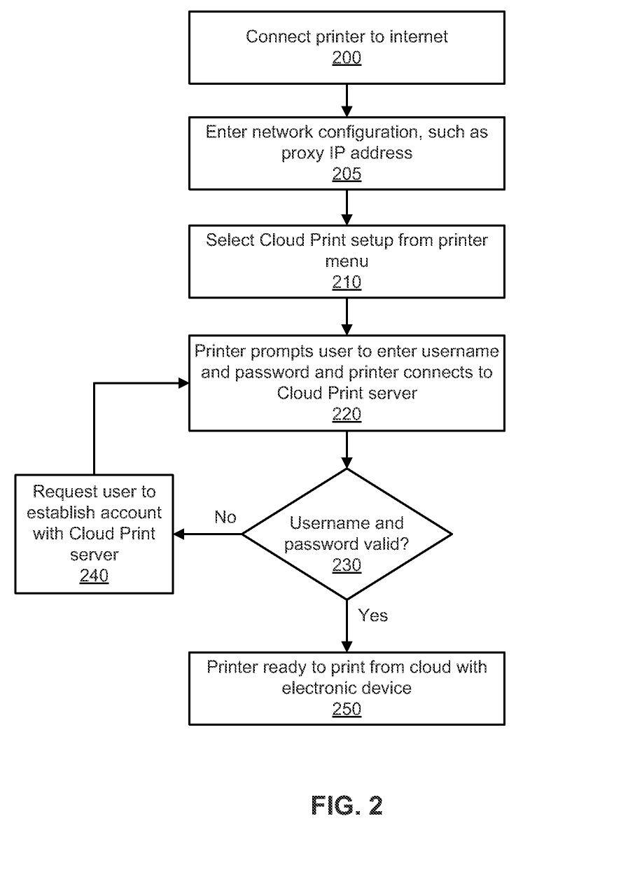

FIG. 2 shows a flow diagram connecting a printer to a cloud print server in accordance with an example embodiment of the present invention.

According to block 200, the printer is connected to a network, such as the internet. By way of example, the printer can be an existing printer of a user or a newly purchased printer (i.e., an out-of-the-box printer).

According to block 205, network configuration information, such as a proxy IP address, is entered. In one embodiment, the printer has a control panel and display through which a user can enter information.

According to block 210, cloud print setup is selected from a menu display at the printer. After the printer is powered-on, the user can navigate through one or more menu options displayed on the printer and select an option to connect the printer to server and cloud print services. Alternatively, the printer can be configured to automatically provide this option to the user (for example, upon power-up, the printer asks the user if he or she desires to connect to the cloud print server). As yet another alternatively, upon power-up and being connected to a network, the printer automatically connects to the cloud print server (i.e., without input from the user).

According to block 220, the printer prompts the user to enter a username and password, and the printer connects to the cloud print server. The username uniquely identifies the user to the cloud print server which stores a list of previously registered users and their associated printers.

According to block 230, a question is asked whether the username and password are valid.

If the username and password are not valid, then flow proceeds to block 240. Here, the cloud print server requests the user to establish a username and password. New users may not be registered with the cloud print server and can register at this time. By way of example, registration includes the user providing personal information, such as name, address, designation other individuals who are authorized to print to the printer, identification of portable electronic devices from which the user will print to the printer, geographical location, phone numbers, email address, etc. Once the user established an account (i.e., username and password), then flow proceeds back to block 220.

If the username and password are valid, then flow proceeds to block 250. Here, the printer is ready to print from the cloud with an electronic device. Once the printer is successfully logged into the cloud, the user can print to the printer from any electronic device that can communicate with the cloud. In one embodiment, the user enters his or her username and password from the electronic device. The cloud print server stores the usernames and their associated installed printers. Alternatively, the electronic device itself is previously registered with the cloud print server as being owned by the user. The user connects to the server with the electronic device, and the server automatically recognizes the electronic device as belonging to the user.

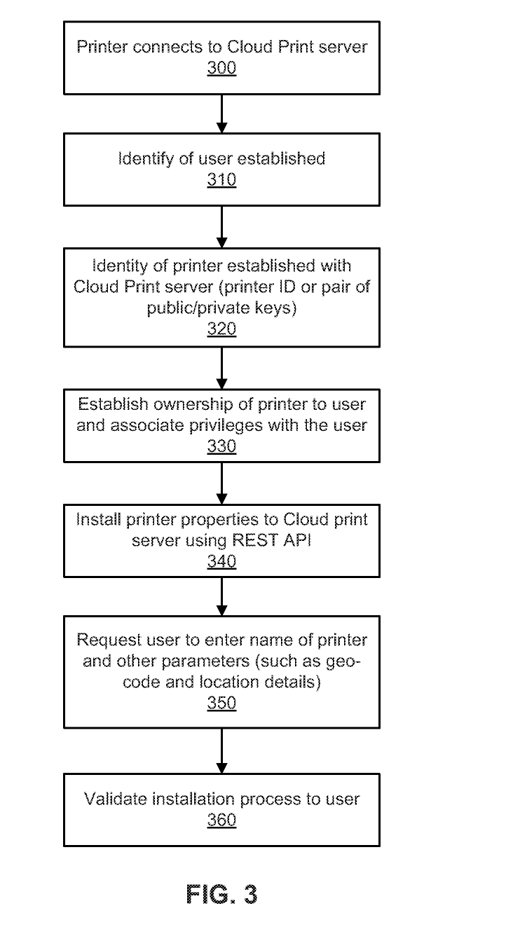

FIG. 3 shows a flow diagram registering and installing a printer with a cloud print server in accordance with an example embodiment of the present invention.

According to block 300, a printer connects to a cloud print server. As shown in FIG. 1 for example, a printer 134 connects through network 150 to a cloud server 120.

According to block 310, an identity of a user is established. For example, a user enters a username and password. Alternatively, an identity of a user can already be assigned to the printer and automatically associated with the printer.

According to block 320, an identity of the printer is established with the cloud print server. For example, a unique printer identification (ID) is transmitted to the cloud printer server. Alternatively, the printer and server exchange a pair of public/private keys, such as a cryptographic key exchange.

According to block 330, ownership of the printer is established to the user and associated privileges with the user. In one embodiment, each printer has a single owner or administrator. The owner of the printer has the highest rights or authority with regard to access privileges. Owners can perform such functions as change printing parameters and configurations for the printer, install a printer for the first time, establish a username and a password, designate other individuals with authority or permission to print, etc. One example embodiment recognizes two different types of users (i.e., individuals who can print to the printer): owners who have full access privileges, and other users who are designated by the owner to print to the printer.

According to block 340, printing properties of the printer are installed or uploaded to the cloud print server. By way of example, such printing properties include, but are not limited to, the following: PDL (PostScript, PCL 5c, PCL 6, PDF, etc.,), Default paper size (Letter or A4 or . . . ), Color support, Duplex support, etc. In one example embodiment, the printing properties are installed using representational state transfer application program interface (REST API).

According to block 350, the user is requested to enter a name of the printer and other parameters, such as geo-code, location of the printer, personal information, etc. As shown in FIG. 1 for example, a single user (such as User 1) can have multiple different printers (such as Printers for User 1 at 134) registered and installed on the cloud. In order to distinguish between these printers, the user or owner designates a name for each of the printers (such as “Home Printer” or “Office Printer” or “Desktop Printer”, etc.). When the user is mobile and away from the physical location of the printers, the user can access each of the printers over the cloud. After the cloud server establishes an identity of the user, the user can select from a list of names to determine to which printer the user desires to print or access.

According to block 360, once the printer is successfully installed, registration or installation of the printer is validated. For example, the user or printer is notified that the printer has been successfully registered and installed with the cloud server. Such notification includes, but is not limited to, printing a page at the printer, displaying a message at the printer, transmitting an email or text to the user or a designated electronic device, etc.

The printer is now web-enabled and ready to print from remote electronic devices of the user.

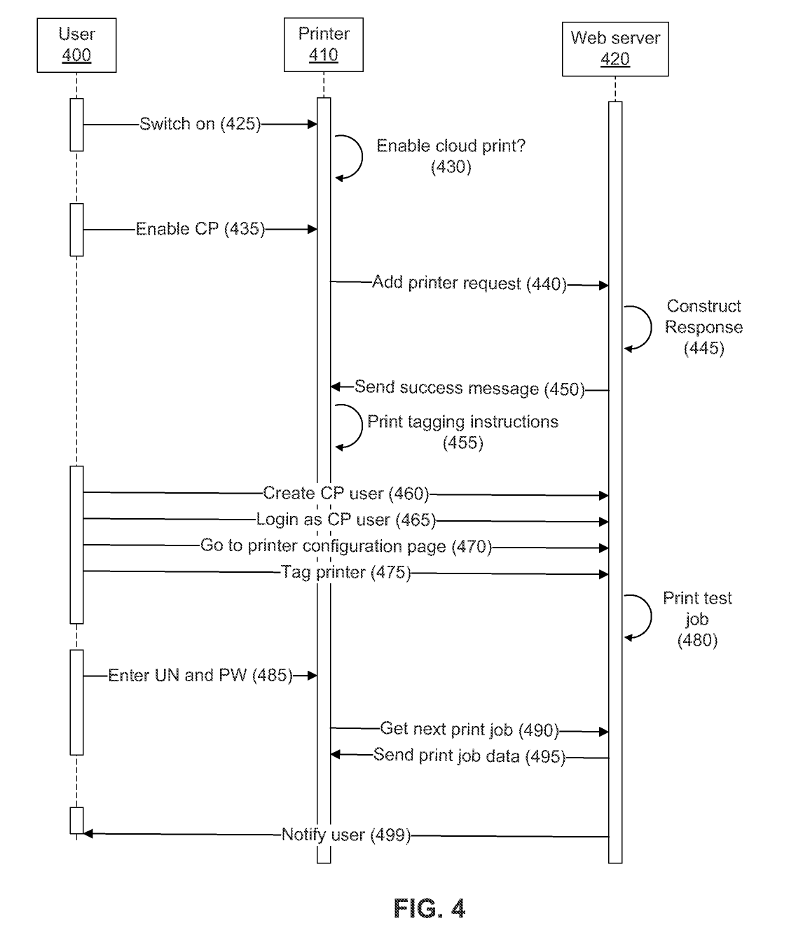

FIG. 4 shows a diagram of a user 400 and printer 410 communicating with a cloud print server 420 in accordance with an example embodiment of the present invention.

At 425, the user 400 switches on the printer 410. A determination at 430 is made as to whether the user desires to enable cloud printing. For example, the printer displays a request to the user, or the user navigates to this option for a menu or display on the printer. Alternatively, enablement of cloud print automatically (or by default) occurs. The printer transmits a request to the server to register and/or install the printer with the server. At 435, cloud print is enabled on the printer. At 440, an add printer request is made to the web server 420. For example, the printer sends an HTTP add printer request to the server.

The cloud server can reject the request for various reasons. For example, the printer was previously installed or already added, the request was not recognized, or the request is not supported or allowed. Further, if the printer was tagged, then a message is sent to the printer. Further, the request to add the printer is secure to avoid false additions to the server (such as using a public and private key exchange).

At 445, the server adds printer and constructs a response. This construction includes adding the printer when the printer is not found as previously being installed, constructing an HTTP response to the printer, and building Page Description Language, PDL, code (PDL is a language that describes an appearance of a printed page in a higher level than output bitmap. PostScript or PS is an example of a PDL).

At 450, the server sends the printer an HTTP message notifying that the printer was successfully registered and installed with the server. Then at 455, the printer prints tagging instructions.

Next, an authorized cloud print user is created at 460, if the user has not previously registered with the server. At 465, the cloud print user logins with designated credentials (such as username and password). At 470, the user navigates or is automatically directed to a printer configuration page. At 475, the printer is tagged with the server by entering a printer identification. Here, a check or verification is performed as to whether the printer is already tagged. In one embodiment, a re-tag attempt fails and generates a notification to the printer owner. The server then generates a print test job for the printer at 480.

After the test page is printed, the user enters a username and password at 485. Once the username and password are verified, the server checks for a next print job request at the printer. If the user sends an invalid username and password, then a notice is sent to the printer and/or user. At 490, the next print job is retrieved from the printer. At 495, print job data is sent to the printer.

Once the printer successfully prints the print job, the server 420 transmits a notice to the user 400 at 499.

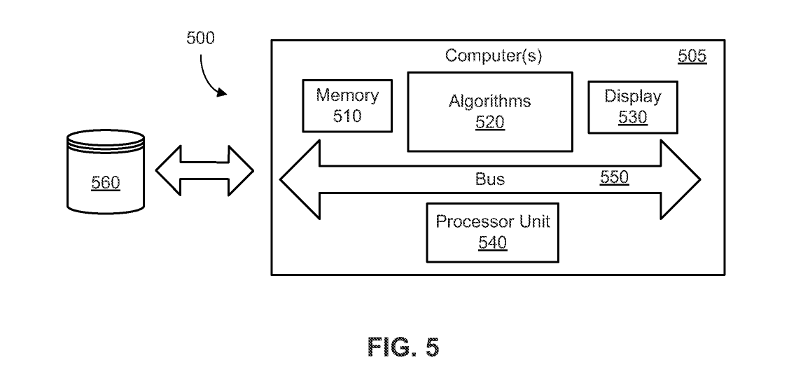

FIG. 5 is a block diagram of a computer system 500 in a cloud print system in accordance with an example embodiment of the present invention. The computer system includes one or more databases or warehouses 560 coupled to one or more computers or servers 505. By way of example, the computer 505 includes memory 510, algorithms 520, display 530, processing unit 540, and one or more buses 550. The processor unit includes a processor (such as a central processing unit, CPU, microprocessor, application-specific integrated circuit (ASIC), etc.) for controlling the overall operation of memory 510 (such as random access memory (RAM) for temporary data storage, read only memory (ROM) for permanent data storage, and firmware). The processing unit 540 communicates with memory 510 and algorithms 520 via one or more buses 550 and performs operations and tasks that install printers and process and/or execute print jobs over the web in a cloud network as explained herein. The memory 510, for 20, example, stores applications, data, programs, algorithms (including software to implement or assist in implementing embodiments in accordance with the present invention) and other data.

The computer 505 is not limited to any particular type of computing device and includes, but is not limited to, a personal computer, a server, a portable computing device, a printer or electronic device that prints, multi-functional devices (such as devices that print, scan, send facsimiles, etc.), and other computers or computing devices.

Definitions

As used herein and in the claims, the following words are defined as follows:

The term “cloud” is a computer network accessible over the internet and/or web that is dynamically scalable with virtualized resources, such as printing resources. Users are not required to have knowledge or expertise in the infrastructure of the cloud that relies on the Internet to satisfy the computing or printing needs of users. The cloud provides computer and/or printer services with business applications that are accessible from a web browser while software and data are stored on servers in the cloud. For example, a printing cloud system supports infrastructure for printer services, platform for the printer services, and software for the printer services.

The term “printer” means an electronic device that prints and includes multi-functional electronic devices that perform functions such as printing, scanning, and/or copying.

The term “web-enabled printer” is a printer that is accessed to print documents over the web.

The term “world wide web” or “web” is a system of linked hypertext documents access through the internet. Using a web browser, a user can view web pages that include text, images, video, and other media and navigate between these pages with hyperlinks.

Example embodiments are discussed in connection with a printer. Example embodiments, however, are not limited to a printer but include various other types of electronic devices that perform one or more functions such as printing, scanning, or copying.

In one example embodiment, one or more blocks or steps discussed herein are automated. In other words, apparatus, systems, and methods occur automatically.

The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In some example embodiments, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
receiving, at a server over a web, a unique identification from a printer to install the printer with the server;
receiving, at the server from the printer, an identity of an owner of the printer;
receiving, at the server from the printer, printing properties of the printer; and
using the unique identification, the identity of the owner, and the printing properties to register and install the printer with the server.

2) The method of claim 1 further comprising, transmitting, by the server to the printer, a confirmation that the printer was successfully installed at the server and is available to print a document from an electronic device of the owner.

3) The method of claim 1, wherein the printer automatically accesses the server upon being connected to the web.

4) The method of claim 1 further comprising, identifying the printer independently of a Transmission Control Protocol and Internet Protocol (TCP/IP) network in which the printer is physically located.

5) The method of claim 1 further comprising, installing the printer across a firewall.

6) The method of claim 1, wherein the printer automatically accesses the server out-of-a-box after being powered-on and connected to the web.

7) The method of claim 1 further comprising, installing the printer at the server without requiring the owner to have knowledge of printer capabilities of the printer.

8) A tangible computer readable storage medium having instructions for causing a computer to execute a method, comprising:
transmitting, from a printer to a cloud server over an internet, identifications that identify both the printer and an owner of the printer;
transmitting, from the printer to the cloud server, printing properties of the printer; and
installing the printer at the cloud server to enable the printer to print jobs received from a portable electronic device of the owner.

9) The tangible computer readable storage medium of claim 8, wherein the printer automatically provides a unique identification to the cloud server upon being removed from a box after purchase, powered-on, and connected to the internet.

10) The tangible computer readable storage medium of claim 8, wherein the identifications includes a public and private key exchange between the printer and the cloud server.

11) The tangible computer readable storage medium of claim 8 further comprising, transmitting an acknowledgement from the cloud server to the printer acknowledging that the printer is successfully registered with the cloud server.

12) The tangible computer readable storage medium of claim 8 further comprising:
receiving, from the printer and designated by the owner, a name for the printer;
storing the name of the printer at the cloud server;
assigning print requests to the printer when the print requests are received from a portable electronic device that identifies the name of the printer.

13) The tangible computer readable storage medium of claim 8 further comprising, using a representational state transfer application program interface (REST API) to identify the printing properties.

14) A printer, comprising:
a memory storing an algorithm; and
a processor connected to the memory to execute the algorithm that:
transmits, to a server over a network, an identification that uniquely identifies the printer; and
transmits, to the server over the network, printing properties of the printer, wherein the identification and the printing properties are automatically transmitted to the server during an auto-setup phase that installs the printer with the server to enable printing to the printer from a remote electronic device.

15) The printer of claim 14, wherein installation of the printer to the server occurs without use of a personal computer.

16) The printer of claim 14, wherein installation of the printer to the server occurs upon the printer being newly purchased, removed from a box, powered-on, and connected to the network.

17) The printer of claim 14, wherein the processor further executes the algorithm to transmit a username and password of an owner of the printer to the server.

18) The printer of claim 14, wherein the processor further executes the algorithm to register the printer with the server so the printer can subsequently receive print jobs from a portable electronic device.

19) The printer of claim 14, wherein the printer displays a notification upon being successfully registered with the server and available to receive print jobs from a remote electronic device.

20) The printer of claim 14, the processor further executes the algorithm to transmit a unique username of an owner of the printer to the server.
